(19) United States
(12) Patent Application Publication
(10) Pub. No.: US 2025/0097011 A1
(43) Pub. Date: Mar. 20, 2025

(54) SYSTEM AND METHOD FOR GENERATION OF SUBSCRIPTION CONCEALED IDENTIFIER (SUCI) IN 5G NETWORKS

(71) Applicant: Giesecke+Devrient Mobile Security Germany GmbH, Munich (DE)

(72) Inventors: Ankit PANDEY, Pune (IN); Santosh Kumar MISHRA, Pune (IN)

(21) Appl. No.: 18/830,000

(22) Filed: Sep. 10, 2024

(30) Foreign Application Priority Data
Sep. 14, 2023 (IN) 202311061958

(51) Int. Cl. H04L 9/06; H04L 9/30

(52) U.S. Cl. CPC H04L 9/0618; H04L 9/3066

(57) ABSTRACT

A system and method are provided for enabling generation of Subscription Concealed Identifier (SUCI) in 5G network. The system performs encryption of a plain text associated with Subscription Permanent Identifier (SUPI) based on an Authenticated Encryption with Associated Data (AEAD)-Advanced Encryption Standard in Galois/Counter Mode (AES-GCM), an Initialization Vector (IV), and Additional authenticated data (AAD). The system obtains public key, cipher text and Message Authentication Code (MAC) tag in parallel process by the AEAD AES-GCM and Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. Finally, system transmits the generated SUCI in response to GET IDENTITY command received by the UICC.

### TECHNICAL FIELD

The present disclosure relates generally to the field of data transmission in communication networks. In particular, the present disclosure relates to a system and a method for enabling the generation of a Subscription Concealed Identifier (SUCI) in a 5G network.

### BACKGROUND

Background description includes information that may be useful in understanding the present invention. It is not an admission that any of the information provided herein is prior art or relevant to the presently claimed invention, or that any publication specifically or implicitly referenced is prior art.

Secured communication between a sender and a receiver in a communication network refers to the establishment of a protected and trusted channel through which information can be transmitted securely therebetween, ensuring confidentiality, integrity, authenticity, and availability. The process generally involves the use of cryptographic techniques and protocols to protect sensitive data from unauthorized access, tampering, or interception.

In 5G communication, an Elliptic Curve Integrated Encryption Scheme (ECIES) scheme is generally used for encrypting and securing a Subscription Permanent Identifier (SUPI) and generating a Subscription Concealed Identifier (SUCI). Further, the Subscription Permanent Identifier (SUPI) is concealed which is called Subscription Concealed Identifier (SUCI) after concealment. These identifiers play important roles in the authentication and identification processes in 5G networks, where an essential part is SUCI generation, which is done using a GET IDENTITY command. The SUCI is concealed form of the SUPI, which is a long-term identifier associated with a user device. The other information includes, but is not limited to a Home Network Public Key Identifier (HNI), a Scheme Output Protection (SOP), a Digest Hiding Indicator (DHI), and the like. The encryption process involves the use of an elliptic curve key pair, consisting of a private key and a corresponding public key. The SUCI can be securely transmitted over the network, protecting the privacy of the subscriber's long-term identifier. Further, the SUPI is a unique identifier associated with the user device in a 5G network. In order to protect the privacy and security of the SUPI, it is concealed using the ECIES scheme. The SUPI is encrypted with the help of an elliptic curve key pair, ensuring that the actual identifier is not revealed during transmission over the network. However, the existing solutions are time-consuming due to multiple key derivations and additional steps involved. The detailed operation of the ECIES scheme has been described later in conjunction with FIG. 3.

Efforts have been made in the art to overcome the above-mentioned problems or requirements. For instance, Patent document number U.S. Ser. No. 11/570,700B2 discloses a method for protecting the privacy of a subscriber identity included in user equipment (UE), where the user equipment pre-calculates several SUCIs in advance. Another patent document number U.S. Ser. No. 11/540,121B2 discloses a Priority fallback of SUCI calculation where the user equipment may consider the first index protection scheme identifier and may support in the Protection Scheme ID List. The calculated SUCI may be transmitted to a network entity (e.g., UDM) for user identity authentication and registration. However, the above-cited references fail to provide a solution to the above-mentioned problems or requirements.

There is, therefore, a need to overcome the above-mentioned drawbacks, shortcomings, and limitations associated with the existing solutions that implement multiple key derivations for authenticating data and establishing secured communication, by providing a simple and cost-effective solution for encrypting Subscription Permanent Identifier (SUPI) to Subscription Concealed Identifier (SUCI) between user devices and networks.

### OBJECTS OF THE PRESENT DISCLOSURE

Some of the objects of the present disclosure, which at least one embodiment herein satisfy are as listed herein below.

It is an object of the present disclosure to overcome the above drawbacks, shortcomings, and limitations associated with existing solutions involving multiple key derivations and encrypting the data, and then MAC calculation in a sequential process.

It is an object of the present disclosure to provide an improved and secured user experience by using Advanced Encryption Standard in Galois/Counter Mode (AES GCM) for providing authenticated encryption.

It is an object of the present disclosure to enable a single block cipher operation by the AES GCM, and provide a parallel process to generate encrypted data and Tag (MAC).

It is an object of the present disclosure to eliminate multiple key derivation processes from ECIES scheme and save additional processing time and enhance the overall performance.

It is an object of the present disclosure to provide optimized and high-speed encryption and decryption operations.

It is an object of the present disclosure to combine encryption, authentication, and additional data processing into a single platform in order to simplify the implementation and reduce the code complexity, lowering the vulnerabilities, and allowing easier maintenance of the platform.

It is an object of the present disclosure to maintain and ensure the integrity and reliability of the authentication process in 3GPP network and private network environments while allowing network operators to optimize the network operations and provide a secure and seamless user experience.

It is an object of the present disclosure to enable selection at runtime by modifying some flag in Operating System (OS) along with current defined approach of protection scheme of 3GPP.

### SUMMARY

The present disclosure relates generally to the field of data transmission in communication networks. In particular, the present disclosure relates to a system and a method for enabling the generation of a Subscription Concealed Identifier (SUCI) in a 5G network.

An aspect of the present disclosure pertains to a system for enabling the generation of a Subscription Concealed Identifier (SUCI) in a 5G network. The system comprises a Universal Integrated Circuit Card (UICC) in communication with one or more user devices and one or more networks. The UICC includes one or more processors coupled with a memory, where the memory is configured to store instructions which when executed by the one or more processors causes the UICC to enable one or more operations. The UICC performs encryption of a plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). Further, the UICC obtains a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. The SUPI type comprises at least one of an International Mobile Subscriber Identity (IMSI) or/and a Network Access Identifier (NAI), where one or more fields are added based on the SUPI type. Finally, transmit the generated SUCI in response to a GET IDENTITY command received by the UICC.

In an aspect, the AEAD-AES GCM enables a single block cipher operation based on an encryption key to generate the SUCI in the 5G network, wherein the system enables the parallel process for a plurality of the blocks.

In an aspect, the UICC may be configured to generate the AAD by integrating a Shared Secret Key and a Home Network Public Key based on an XOR operation.

In an aspect, the system is configured to generate the SUCI by concealing the SUPI based on the ECIES in 5G network.

In an aspect, the shared secret key is 256-bits generated in a Key Agreement procedure is divided to generate primarily the AES-GCM key which is 128-bits and followed by the IV which is 96-bits.

Another aspect of the present disclosure pertains to a method for enabling the generation of a Subscription Concealed Identifier (SUCI) in 5G network. The method comprises the step of performing, by a Universal Integrated Circuit Card (UICC), encryption of plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). The method further comprises the step of obtaining, by the UICC, a public key, a cipher text, and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. The SUPI type comprises at least one of an International Mobile Subscriber Identity (IMSI) or/and a Network Access Identifier (NAI), where one or more fields are added based on the SUPI type. Finally, the method comprises the step of transmitting, by the UICC, the generated SUCI in response to a GET IDENTITY command received by the UICC.

In another aspect, the AEAD-AES GCM enables a single block cipher operation based on an encryption key to generate the SUCI in the 5G network, wherein the system enables the parallel process for a plurality of the blocks.

In yet another aspect, the method may comprise the steps of generating, by the UICC, the AAD by integrating a Shared Secret Key and a Home Network Public Key based on an XOR operation.

In yet another aspect, the method may comprise the steps of generating, by the UICC, the SUCI by concealing the SUPI based on ECIES in the 5G network.

In an aspect, the shared secret key is 256-bits generated in a Key Agreement procedure is divided to generate primarily the AES-GCM key which is 128-bits and followed by the IV which is 96-bits.

Various objects, features, aspects, and advantages of the present disclosure will become more apparent from the following detailed description of preferred embodiments, along with the accompanying drawing figures in which like numerals represent like features.

Within the scope of this application, it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible

### BRIEF DESCRIPTION OF DRAWINGS

The accompanying drawings are included to provide a further understanding of the present invention and are incorporated in and constitute a part of this specification. The drawings illustrate exemplary embodiments of the present invention and, together with the description,

FIG. 1 illustrates exemplary network architecture of the proposed system for enabling generation of Subscription Concealed Identifier (SUCI) in a 5G network, in accordance with an embodiment of the present disclosure.

FIG. 2 illustrates a system architecture of the processing device, in accordance with an embodiment of the present disclosure.

FIG. 3 illustrates a flow diagram depicting the steps involved in the existing ECIES scheme implemented in 5G networks.

FIG. 4 illustrates a flow diagram depicting the steps involved in the proposed system for enabling the generation of a Subscription Concealed Identifier (SUCI) in a 5G network, in accordance with an embodiment of the present disclosure.

FIG. 5 illustrates a proposed method for enabling generation of Subscription Concealed Identifier (SUCI) in a 5G network, in accordance with an embodiment of the present disclosure.

FIG. 6 illustrates an exemplary computer system in which or with which the processing device, the server, and the user device of the present invention can be utilized, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

The present disclosure relates generally to the field of data transmission in communication networks. In particular, the present disclosure relates to a system and a method for enabling the generation of a Subscription Concealed Identifier (SUCI) in a 5G network.

An aspect of the present disclosure pertains to a system for enabling the generation of a Subscription Concealed Identifier (SUCI) in a 5G network. The system comprises a Universal Integrated Circuit Card (UICC) in communication with one or more user devices and one or more networks. The UICC includes one or more processors coupled with a memory, where the memory is configured to store instructions which when executed by the one or more processors causes the UICC to enable one or more operations. The UICC performs encryption of a plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). Further, the UICC obtains a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. The SUPI type comprises at least one of an International Mobile Subscriber Identity (IMSI) or/and a Network Access Identifier (NAI) where one or more fields are added based on the SUPI type. Finally, transmit the generated SUCI in response to a GET IDENTITY command received by the UICC.

In an aspect, the AEAD-AES GCM enables a single block cipher operation based on an encryption key to generate the SUCI in the 5G network, wherein the system 102 enables the parallel process for a plurality of the blocks.

In an aspect, the UICC may be configured to generate the AAD by integrating a Shared Secret Key and a Home Network Public Key based on an XOR operation.

In an aspect, the system is configured to generate the SUCI by concealing the SUPI based on the ECIES in 5G network.

In an aspect, the shared secret key is 256-bits generated in a Key Agreement procedure is divided to generate primarily the AES-GCM key which is 128-bits and followed by the IV which is 96-bits.

Another aspect of the present disclosure pertains to a method for enabling the generation of Subscription Concealed Identifier (SUCI) in a 5G network. The method comprises the step of performing, by a Universal Integrated Circuit Card (UICC), encryption of plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). The method further comprises step of obtaining, by the UICC, a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. The SUPI type comprises at least one of an International Mobile Subscriber Identity (IMSI) or/and a Network Access Identifier (NAI), where one or more fields are added based on the SUPI type. Finally, the method comprises the step of transmitting, by the UICC, the generated SUCI in response to a GET IDENTITY command received by the UICC.

In another aspect, the AEAD-AES GCM enables a single block cipher operation based on an encryption key to generate the SUCI in the 5G network, wherein the system 102 enables the parallel process for a plurality of the blocks.

In yet another aspect, the method may comprise the steps of generating, by the UICC, the AAD by integrating a Shared Secret Key and a Home Network Public Key based on an XOR operation.

In yet another aspect, the method may comprise the steps of generating, by the UICC, the SUCI by concealing the SUPI based on ECIES in 5G network.

In an aspect, the shared secret key is 256-bits generated in a Key Agreement procedure is divided to generate primarily the AES-GCM key which is 128-bits and followed by the IV which is 96-bits.

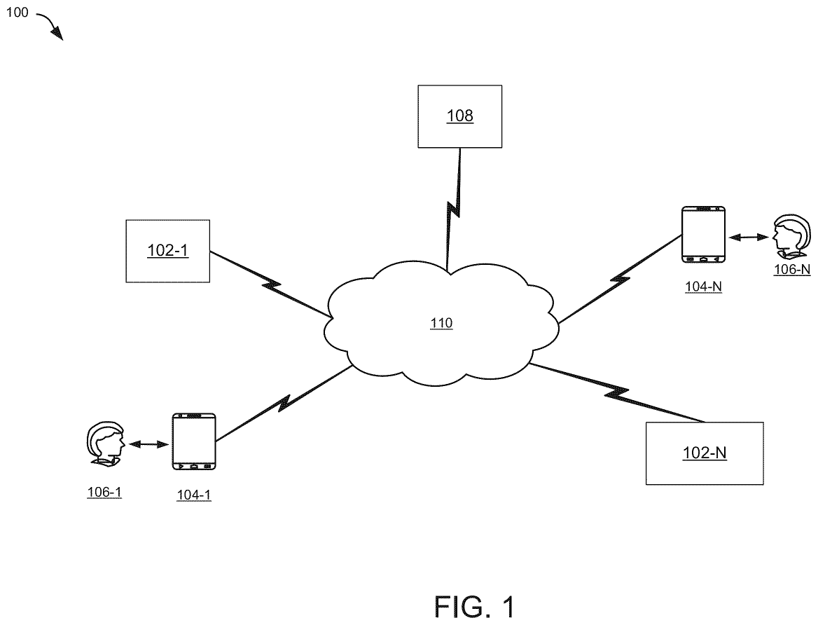

Referring to FIG. 1, the exemplary network architecture of the proposed system 100 for enabling generation of Subscription Concealed Identifier (SUCI) in a 5G network. The proposed system 100 can include one or more networks 102-1, 102-2 . . . 102-N (collectively referred to as network 102), one or more user devices 104-1, 104-2 . . . 104-N (collectively referred to as the user device 104, and interchangeably referred to as computing device 104, and Mobile Equipment (ME) 104, herein) associated with one or more users 106-1, 106-2 . . . 106-N (collectively referred as the user 106), and a communication network 110. The system 100 can further include a Universal Integrated Circuit Card (UICC) 108 that can be in communication with the networks 102 and the user devices 104. The networks 102, the user devices 104, and UICC 108 can be in communication with each other through a communication network 110.

In an embodiment, the UICC 108 can be configured to perform encryption of a plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). The plain text is part of SUPI (Subscription Permanent Identifier). When the SUPI type is International Mobile Subscriber Identity (IMSI) then the plain text is Mobile Subscriber Identification Number (MSIN) part of the IMSI, and when the SUPI type is Network Access Identifier (NAI), then the plain text is a User Name of the NAI. The system can be configured to generate the AAD by integrating a Shared Secret Key and a Home Network Public Key based on an XOR operation. The shared secret key is 256-bits generated in a Key Agreement procedure is divided to generate primarily the AES-GCM key which is 128 bits and followed by the IV which is 96 bits.

In an embodiment, the UICC 108 can be configured to obtain a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network. The one or more parameters comprise at least one of a SUPI type, a Mobile Country Code (MCC), a Mobile Network Code (MNC), or/and a protection scheme ID. Further, the SUPI type comprises at least one of an International Mobile Subscriber Identity (IMSI) or/and a Network Access Identifier (NAI). In addition, the one or more parameters can also include several components of the NAI such as a Network Specific Identifier (NSI), a Global Line Identifier (GLI), or/and a Group Cable Identifier (GCI). The AEAD-AES GCM enables a single block cipher operation based on an encryption key to generate the SUCI in the 5G network, where the system 100 enables the parallel process for a plurality of the blocks. The system is configured to generate the SUCI by concealing the SUPI based on the ECIES in 5G network. Finally, transmit the generated SUCI in response to a GET IDENTITY command received by the UICC.

In an embodiment, the user device 104 can communicate with the network 102 via a set of executable instructions residing on any operating system, including but not limited to, Android™, iOS™, Kai OS™, Windows™, and the like. In an embodiment, the user device/computing device/ME 104 may include, but is not limited to, mobile phones, smartphones, virtual reality (VR) devices, augmented reality (AR) devices, laptops, general-purpose computers, desktop, personal digital assistants, tablet computers, mainframe computers, or any other computing device, wherein the user device 104 may include one or more in-built or externally coupled accessories including, but not limited to, a visual aid device such as camera, audio aid, a microphone, a keyboard, input devices for receiving input from a user such as a touchpad, touch-enabled screen, electronic pen, and the like. It may be appreciated that the user device/computing device/mobile equipment 104 may not be restricted to the mentioned devices and various other devices may be used. A smart computing device may be one of the appropriate systems for storing data and other private/sensitive information.

In another exemplary embodiment, the UICC 108 may include or comprise, by way of example but not limitation, one or more of a SIM (Subscriber Identity Module) card, a SIM Chip a smart card, a Telecom Card, a Global System for Mobile communications (GSM) card, a hardware supporting component for establishment of mobile network security and subscriber management. The one or more processors may be executing code to function as a server, one or more machines performing server-side functionality as described herein, at least a portion of any of the above, or some combination thereof.

In another exemplary embodiment, the communication network 110 can be a wireless network, a wired network, or a combination thereof that is implemented as one of the different types of networks, such as a Mobile GSM network, Intranet, Local Area Network (LAN), Wide Area Network (WAN), Internet, and the like as the case may be. Further, communication network 110 can either be a dedicated network or a shared network. The shared network represents an association of the different types of networks that uses a variety of protocols, for example, Hypertext Transfer Protocol (HTTP), Transmission Control Protocol/Internet Protocol (TCP/IP), Wireless Application Protocol (WAP), and the like.

The UICC 108 may be implemented as a combination of hardware and programming (for example, programmable instructions) to implement one or more functionalities of the one or more processors. In examples described herein, such combinations of hardware and programming may be implemented in several different ways. For example, the programming for the one or more processors may be processor executable instructions stored on a non-transitory machine-readable storage medium and the hardware for the one or more processors may comprise a processing resource (for example, one or more processors), to execute such instructions. In the present examples, the machine-readable storage medium may store instructions that, when executed by the processing resource, implement the one or more processors. In such examples, the system 100 may comprise the machine-readable storage medium storing the instructions and the processing resource to execute the instructions, or the machine-readable storage medium may be separate but accessible to the system and the processing resource. In other examples, the one or more processors may be implemented by electronic circuitry. In an aspect, the database may comprise data that may be either stored or generated as a result of functionalities implemented by any of the components of the processor or the processing engines.

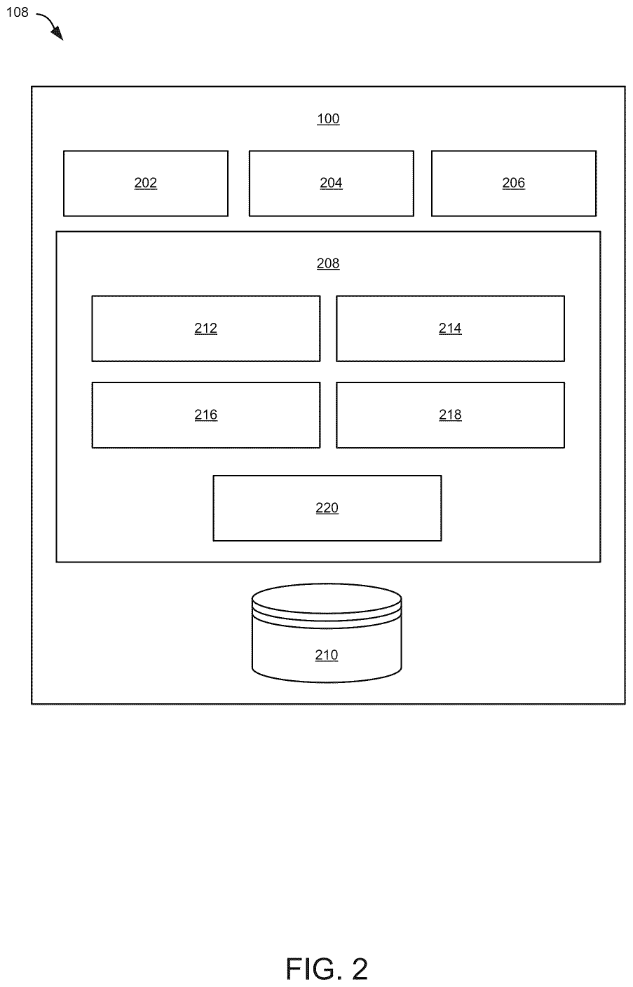

Referring to FIG. 2, a system architecture of the processing device is disclosed. The UICC 108 can include one or more processor(s) 202 that may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 100. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random Access Memory (RAM), or non-volatile memory such as Erasable Programmable Read-Only Memory (EPROM), flash memory, and the like.

The UICC 108 may include an interface(s) 206. The interface(s) 206 may comprise a variety of interfaces, for example, interfaces for data input and output devices, referred to as I/O devices, storage devices, and the like. The interface(s) 206 may facilitate communication to/from the processing device 108. The interface(s) 206 may also provide a communication pathway for one or more components of the UICC 108. Examples of such components include, but are not limited to, processing unit/engine(s) 208 and a local database 210.

In an embodiment, the processing unit/engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the processing device 108 may comprise the machine-readable storage medium storing the instructions and the processing resource to execute the instructions, or the machine-readable storage medium may be separate but accessible to the processing device 108 and the processing resource. In other examples, the processing engine(s) 208 may be implemented by electronic circuitry.

In an embodiment, the local database 210 may comprise data that may be either stored or generated as a result of functionalities implemented by any of the components of the processor 202 or the processing engines 208. In an embodiment, the local database 210 may be separate from the processing device 108.

In an exemplary embodiment, the processing engine 208 may include one or more engines selected from any of a data acquisition engine 212, a protocol analyzing engine 214, a monitoring engine 216, a calculating engine 218 and other engine(s) 220 having functions that may include but are not limited to testing, storage, and peripheral functions, such as wireless communication unit for remote operation, audio unit for alerts and the like.

In an embodiment, the data acquisition engine 212 can enable the processing device 108 to receive at least one cipher text, a symmetric key, and a MAC from the user device 104 upon initiation of a request by the user device 104 for the establishment of a secured communication between the user devices 104 and the networks 102.

In an embodiment, the protocol analyzing engine 214 can enable network protocols such as but not limited to an Advanced Encryption Standard in Galois/Counter Mode (AES GCM) protocol. The protocol analyzing engine 214 can enable the processing device 108 to capture, decode, and interpret the received data exchanged between user device 104 and network to gain insights into network communication and troubleshoot issues.

In an embodiment, the monitoring engine 216 can monitor, collect, and analyze the data exchanged between the user device 104 and the network 102. The monitoring engine 216 can further enable proactive monitoring and management of network infrastructure, applications, and services associated with the system 100.

In an embodiment, the calculating engine 218 can enable the calculation of SUCI which involves the transformation and encryption of the SUPI in order to create a privacy-preserving identifier for secure communication in 5G networks.

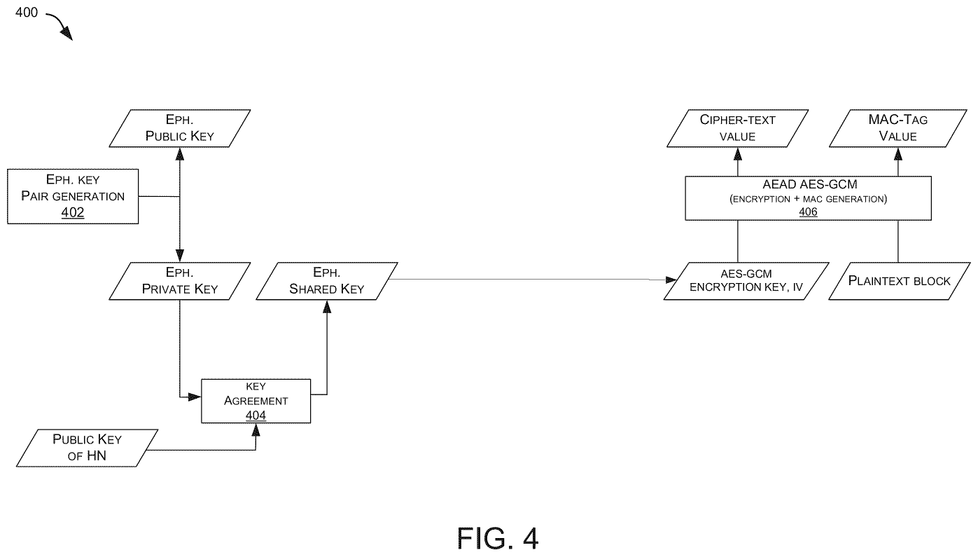

As illustrated in FIG. 4, the flow diagram depicting the operation of the proposed ECIES scheme 400 implemented in 5G networks is disclosed. At step 402, the ECIES scheme 400 can include elliptic curve cryptography-based Key Pair generation, where the user device and the network (sender and receiver) each generate an elliptic curve key pair consisting of a private key and a corresponding public key. Further, at step 404, the user device and the network (sender and receiver) can use their respective private keys and each other's public keys to perform a key agreement protocol, such as Diffie-Hellman key exchange, to establish a shared secret key. The Shared Secret key (256-bits) generated in ‘Key Agreement’ procedure is divided to generate 128-bits AES-GCM key and 96-bits IV. First 128-bits from Shared Secret key are used for AES-GCM key and the last 96-bits from Shared Secret key are used for the IV

Further, at step 406 the AEAD—AES GCM (combination of encryption and MAC generation) uses a single block cipher operation, and it can be processed in parallel to obtain a public key, a cipher text, and a Message Authentication Code (MAC) tag along with one or more parameters for enabling generation of the SUCI in the 5G network. The one or more parameters comprise at least one of a SUPI type, a Mobile Country Code (MCC), a Mobile Network Code (MNC), or/and a protection scheme ID.

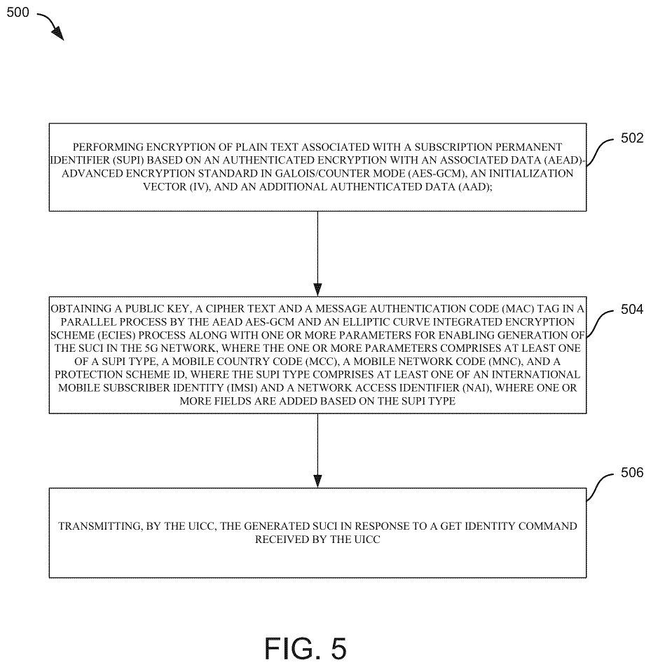

Referring to FIG. 5, method 500 for establishing a secured communication between user device and network is disclosed. Method 500 may involve the networks 102, user devices 104, and the processing device associated with the system of FIG. 1. Method 500 can include step 502 of performing, by a Universal Integrated Circuit Card (UICC), encryption of plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD). Further, method 500 can include step 504 of obtaining, by the UICC, a public key, a cipher text, and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network as processed at step 502. The one or more parameters comprise at least one of a SUPI type, a Mobile Country Code (MCC), a Mobile Network Code (MNC), or/and a protection scheme ID. The SUPI type comprises at least one of an International Mobile Subscriber Identity (IMSI) or/and a Network Access Identifier (NAI), where one or more fields are added based on the SUPI type. Furthermore, method 500 can include step 506 of transmitting, by the UICC, the generated SUCI in response to a GET IDENTITY command received by the UICC.

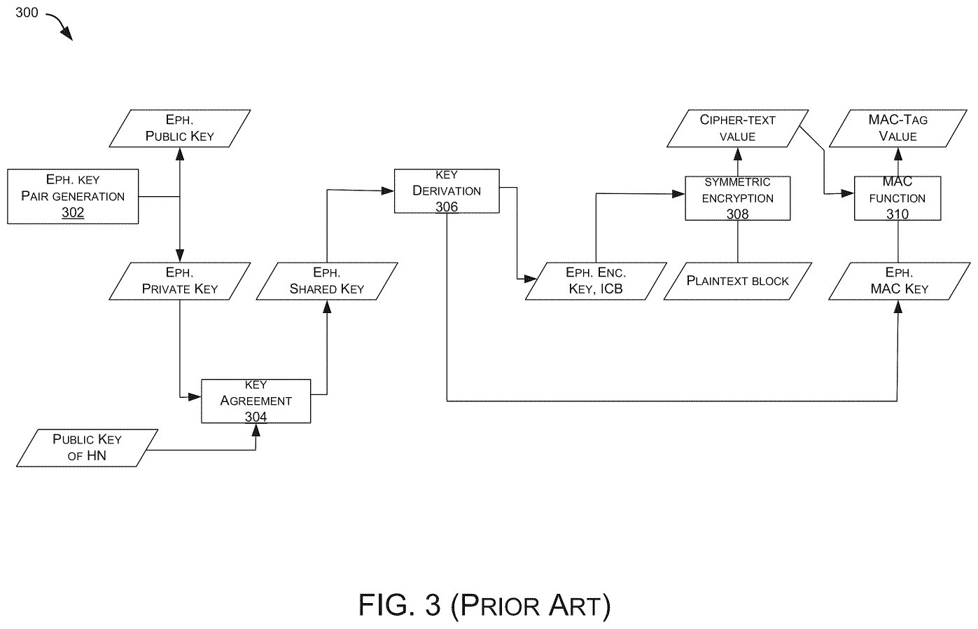

As illustrated in FIG. 3, the flow diagram depicting the operation of the existing ECIES scheme 300 implemented in 5G networks is disclosed. At step 302, the ECIES scheme 300 can include elliptic curve cryptography-based Key Pair generation, where the user device and the network (sender and receiver) each generate an elliptic curve key pair consisting of a private key and a corresponding public key. Further, at step 304, the user device and the network (sender and receiver) can use their respective private keys and each other's public keys to perform a key agreement protocol, such as Diffie-Hellman key exchange, to establish a shared secret key. Furthermore, at step 306, the user device (sender) can use the shared secret key to generate a symmetric encryption key, which can then be used to encrypt the message using a symmetric encryption algorithm like AES (Advanced Encryption Standard). The symmetric key generation can be done using the shared secret key which includes two rounds to generate AES Encryption Key and hash-based message authentication (HMAC) key. Furthermore, the ECIES scheme 300 can include step 308 of enabling encryption using AES (AES-128 in CTR mode), followed by another step 310 of HMAC calculation on ciphered data using SHA-256. As can be seen, the ECIES scheme 300 can be time-consuming due to multiple keys derivations such as encryption key EK and authentication key MK using shared secret key, and encryption SUPI to SUCI with AES CTR/EK. Moreover, the ECIES scheme 300 involves the additional calculation of message authentication code (MAC) using authentication key MK with HMAC protocol, which is not required in the present invention (system 100 and method 500). Besides, no extra ‘Key Derivation’ processing and ‘MAC calculation’ processing is required by the processing device 108 (which is required in the current ECIES scheme 300).

For encrypting SUPI to SUCI, instead of using algorithm AES CTR and separately calculating message authentication code (MAC) using authentication key MK with HMAC protocol as required in the existing ECIES scheme 300, the system 100 and method 500 can use AEAD AES GCM protocol for the SUPI/SUCI encryption, which can also output the cipher text, and a Message Authentication Code (MAC) tag in a parallel process. Some steps of the ECIES scheme may be used only for generating the enc key EK because auh key MK is not required for AEAD (AES-GCM) protocol. The AEAD (AES-GCM) protocol use only one key for processing and generates cipher text, and a Message Authentication Code (MAC) tag in a parallel process, thus no separate auh key MK is required while using AEAD (AES-GCM) protocol.

In an embodiment, the SUPI to SUCI encryption process can use the AEAD AES GCM protocol, which results in a cipher text, and a Message Authentication Code (MAC) tag in a parallel process. The input parameters for the AEAD AES GCM protocol can be plain text, AES 128 bit key, IV (96 bits), and Additional authenticated data (AAD). Further, the shared Secret (256 bits) can be divided as the symmetric key for AES GCM (128 bits) and IV (96 bits). The AAD can be generated as ‘(Shared Secret Key) XOR (Home Network Public Key)’. Thus, in system 100 and method 500 no extra ‘Key Derivation’ processing and ‘MAC calculation’ processing is required by the processing device 108.

It is to be appreciated by a person skilled in the art that as AEAD AES GCM protocol implemented in the present invention (system 100 and method 500) uses a single block cipher operation, and it can be processed in parallel, therefore for multiple block size input data, the AES GCM (system 100 and method 400) can be faster than AES CTR+HMAC (ECIES scheme 300) that requires block cipher and hash function and which cannot be processed in parallel as HMAC is calculated on ciphered data thus both operations are sequential. In addition, in the case of AES GCM protocol (system 100 and method 400), only one Key is required, however, for AES CTR+HMAC (ECIES scheme 300), two keys are required (one for encryption and the other one for MAC calculation).

Thus, the present invention (involving AEAD AES GCM protocol) is more secure as it provides Authenticated Encryption i.e., in addition to providing confidentiality for the Plaintext that is encrypted, provides a way to check its integrity and authenticity. In addition, the present invention can process in parallel and is faster for multiple block input data. Moreover, there is no requirement of separate HMAC for MAC calculation in the present invention and only one key is required, thus the ‘Key Derivation’ process can be skipped from ECIES scheme in the present invention which can save additional processing time.

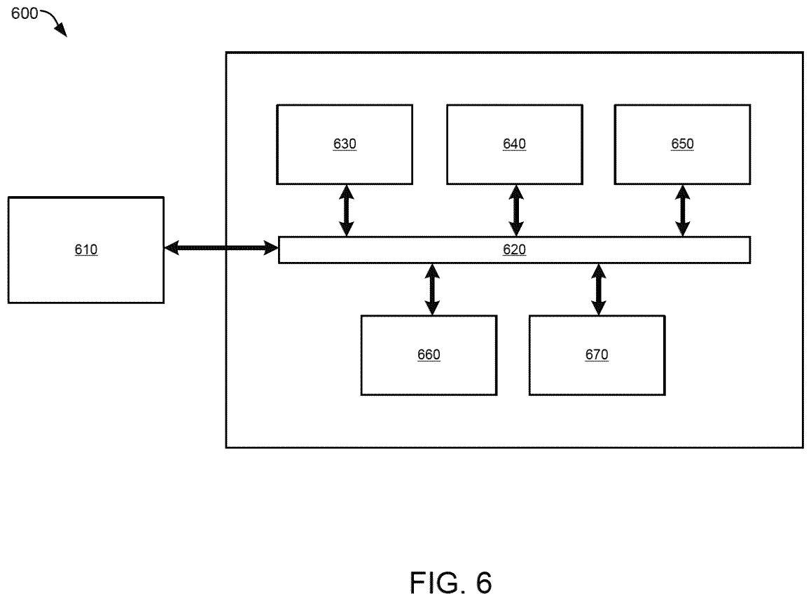

Referring to FIG. 6, a computer system 600 in which or with which the UICC 108, the user device 104, and the network 102 of the system 100 and method 500 may be implemented for enabling generation of Subscription Concealed Identifier (SUCI) in a 5G network is disclosed. The computer system 600 includes an external storage device 610, a bus 620, a main memory 630, a read-only memory 640, a mass storage device 660, a communication port 660, and a processor(s) 670. The processor 670 is implemented as one or more microprocessors, microcomputers, microcontrollers, digital signal processors, central processing units, logic circuitries, and/or any devices that manipulate data based on operational instructions. Among other capabilities, processor(s) 670 are configured to fetch and execute computer-readable instructions stored in a memory of the sink device. The memory 640 stores one or more computer-readable instructions or routines, which are fetched and executed to create or share the data units over a network service. Memory 630, 640 comprise any non-transitory storage device comprising, for example, volatile memory such as RAM, or non-volatile memory such as EPROM, flash memory, and the like.

In an embodiment, the computer system 600 also comprises an interface(s). The interface(s) comprises a variety of interfaces, for example, interfaces for data input and output devices referred to as I/O devices, storage devices, and the like. The interface(s) facilitates communication between the UICC 108, user device 106 and the network 102. The interface(s) also provides a communication pathway for one or more components of the UICC 108, network 102, and user device 106. Examples of such components comprise, but are not limited to, processing engine(s) and database. The interface comprises a platform for communication with the devices/servers to read real-time data/write data in the UICC 108, network 102, and user device 106, respectively, and to communicate with the other devices. Interfaces comprise a Graphical interface that allows user to feed inputs, to type/write/upload the data and certificates, and other software and hardware interfaces, for example, interfaces for peripheral device(s), such as a keyboard, a mouse, an external memory, and a printer.

A person skilled in the art will appreciate that computer system 600 may include more than one processor and communication ports. Examples of processor 670 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 670 may include various modules associated with embodiments of the present invention. Communication port 660 can be any of an RS-232 port for use with a modem-based dialup connection, a 10/100 Ethernet port, a Gigabit or 10 Gigabit port using copper or fiber, a serial port, a parallel port, or other existing or future ports. Communication port 660 may be chosen depending on a network, such a Local Area Network (LAN), Wide Area Network (WAN), or any network to which the computer system connects.

In an embodiment, the memory 630 can be Random Access Memory (RAM), or any other dynamic storage device commonly known in the art. Read only memory can be any static storage device(s) e.g., but not limited to, a Programmable Read Only Memory (PROM) chips for storing static information e.g., start-up or BIOS instructions for processor 670. Mass storage 660 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

In an embodiment, the bus 620 communicatively couples the processor(s) 670 with the other memory, storage, and communication blocks. Bus 520 can be, e.g. a Peripheral Component Interconnect (PCI)/PCI Extended (PCI-X) bus, Small Computer System Interface (SCSI), USB or the like, for connecting expansion cards, drives, and other subsystems as well as other buses, such a front side bus (FSB), which connects processor 670 to a software system.

In another embodiment, operator and administrative interfaces, e.g. a display, keyboard, and a cursor control device, may also be coupled to bus 620 to support direct operator interaction with computer system 600. Other operator and administrative interfaces can be provided through network connections connected through communication port 660. External storage device 610 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are comprised to enable a person having ordinary skill in the art to make and use the invention when combined with information and knowledge available to the person having ordinary skill in the art.

### Advantages of the Invention

The proposed invention overcomes the above drawbacks, shortcomings, and limitations associated with existing solutions involving multiple key derivations and encrypting the data, and then MAC calculation in a sequential process.

The proposed invention provides an improved and secure user experience by using Advanced Encryption Standard in Galois/Counter Mode (AES GCM) for providing authenticated encryption.

The proposed invention enables a single block cipher operation by the AES GCM, and provides a parallel process to generate encrypted data and Tag (MAC).

The proposed invention eliminates multiple key derivation processes from the ECIES scheme and saves additional processing time and enhances the overall performance.

The proposed invention provides optimized and high-speed encryption and decryption operations.

The proposed invention combines encryption, authentication, and additional data processing into a single platform in order to simplify the implementation and reduce the code complexity, lowering the vulnerabilities, and allowing easier maintenance of the platform.

The proposed invention maintains and ensures the integrity and reliability of the authentication process in 3GPP network and private network environments while allowing network operators to optimize the network operations and provide a secure and seamless user experience.

The proposed invention enables selection at runtime by modifying some flags in Operating System (OS) along with the current defined approach of the protection scheme of 3GPP.

1. A system for enabling generation of Subscription Concealed Identifier (SUCI) in a 5G network, the system comprising:
a Universal Integrated Circuit Card (UICC) in communication with one or more user device and one or more network, the UICC comprising one or more processors coupled with a memory, wherein said memory stores instructions which when executed by the one or more processors causes the UICC to:
perform encryption of a plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD);
obtain a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network, wherein the one or more parameters comprises at least one of a SUPI type, a Mobile Country Code (MCC), a Mobile Network Code (MNC), or/and a protection scheme ID, wherein the SUPI type comprises at least one of an International Mobile Subscriber Identity (IMSI) or/and a Network Access Identifier (NAI), wherein one or more fields are added based on the SUPI type; and
transmit the generated SUCI in response to a GET IDENTITY command received by the UICC.

2. The system as claimed in claim 1, wherein the AEAD-AES GCM enables a single block cipher operation based on an encryption key to generate the SUCI in the 5G network, wherein the system enables the parallel process for a plurality of the blocks.

3. The system as claimed in claim 1, wherein the system is configured to:
generate the AAD by integrating a Shared Secret Key and a Home Network Public Key based on an XOR operation.

4. The system as claimed in claim 1, wherein the system is configured to generate the SUCI by concealing the SUPI based on the ECIES in the 5G network.

5. The system as claimed in claim 1, wherein the shared secret key is 256-bits generated in a Key Agreement procedure is divided to generate primarily the AES-GCM key which is 128-bits and followed by the IV which is 96-bits.

6. A method for enabling generation of Subscription Concealed Identifier (SUCI) in a 5G network, the method comprising the steps of:
performing, by a Universal Integrated Circuit Card (UICC), encryption of plain text associated with a Subscription Permanent Identifier (SUPI) based on an Authenticated Encryption with an Associated Data (AEAD)-Advanced Encryption Standard in Galois/Counter Mode (AES-GCM), an Initialization Vector (IV), and an Additional authenticated data (AAD);
obtaining, by the UICC, a public key, a cipher text and a Message Authentication Code (MAC) tag in a parallel process by the AEAD AES-GCM and an Elliptic Curve Integrated Encryption Scheme (ECIES) process along with one or more parameters for enabling generation of the SUCI in the 5G network, wherein the one or more parameters comprises at least one of a SUPI type, a Mobile Country Code (MCC), a Mobile Network Code (MNC), or/and a protection scheme ID, wherein the SUPI type comprises at least one of an International Mobile Subscriber Identity (IMSI) or/and a Network Access Identifier (NAI), wherein one or more fields are added based on the SUPI type; and
transmitting, by the UICC, the generated SUCI in response to a GET IDENTITY command received by the UICC.

7. The method as claimed in claim 6, wherein the AEAD-AES GCM enables a single block cipher operation based on an encryption key to generate the SUCI in the 5G network, wherein the system enables the parallel process for a plurality of the blocks.

8. The method as claimed in claim 6, wherein the method comprises the steps of:
generating, by the UICC, the AAD by integrating a Shared Secret Key and a Home Network Public Key based on an XOR operation.

9. The method as claimed in claim 6, wherein the method comprises the steps of:
generating, by the UICC, the SUCI by concealing the SUPI based on ECIES in 5G network.

10. The method as claimed in claim 6, wherein the shared secret key is 256-bits generated in a Key Agreement procedure is divided to generate primarily the AES-GCM key which is 128-bits and followed by the IV which is 96-bits.
